(19) United States
(12) Patent Application Publication
(10) Pub. No.: US 2004/0069414 A1
(43) Pub. Date: Apr. 15, 2004

(54) Evaporation apparatus for solvent fuel

(76) Inventors: Ta-Ming Chuang, Los Angeles, CA (US); Chih-Ping Lee, Taipei (TW)

Correspondence Address: BRUCE H. TROXELL, 5205 LEESBURG PIKE, SUITE 1404, FALLS CHURCH, VA, 22041, US

(21) Appl. No.: 10/266,770

(22) Filed: Oct. 9, 2002

(51) Int. Cl. B01D 1/22; B01D 1/14; B01D 1/06; B01D 1/00

(52) U.S. Cl. 159/16.1; 159/27.3; 159/44; 159/15

(57) ABSTRACT

An evaporation apparatus for solvent fuel comprises an evaporation tank containing the solvent fuel. A blower is installed on the top of the tank with its one end connected to an air inlet pipe, which has a blower switch associated with a check valve. The air inlet pipe is deeply extended to the bottom of the tank for introducing the air into the tank so as to evaporate the solvent fuel. The other end of the blower is connected to a pressure switch for controlling operation of the blower by detecting inner pressure of the tank. A constant temperature rod is provided nearby the bottom of the tank with its one end in connection with a temperature control switch to maintain the tank at a constant temperature. Besides, a scale graduation tube is provided for measuring the fuel quantity. Unlike conventional “Liquid Petroleum Gas” (LPG) tank, this evaporation apparatus is able to operate without any compressed pressure, and the user could add the solvent fuel through a refill hole (solvent fuel inlet) without the fear of explosion or leakage of poisonous substance.

### BACKGROUND OF THE INVENTION

1. Field of the Invention

The present invention relates to an evaporation apparatus for solvent fuel, and more particularly, to an evaporation apparatus having a container free from compressed pressure, and is highly safe and convenient to add the solvent fuel in time of need without any danger.

2. Description of the Prior Art

A commonly used liquid fuel, for example, “Liquid Petroleum Gas (LPG)”, is stored in a fuel tank under the critical liquefaction pressure. This liquid petroleum gas is released to flow out in a gaseous state through an exit formed at the upper end of the tank so as to supply to a burner.

In this version, the tank containing such a pressurized liquid fuel is always in danger of explosion causing a threat to security of the vicinity where this untimely bomb is located.

It is what the object the inventor has endeavored for years seeking for a solution to the above-mentioned problem of the conventional storage apparatus for liquid fuel, and at last has worked out the solution by providing a safe and handy evaporation apparatus for solvent fuel of the present invention.

### SUMMARY OF THE INVENTION

Accordingly, it is an object of the present invention to provide an evaporation apparatus for solvent fuel capable of keeping the fuel container in almost non-pressure state.

To achieve this object, a solvent fuel, instead of the conventional pressurized liquid fuel, is utilized which is evaporated into a gaseous state by introducing the air into the container in non-pressure state so as to release the fear of possible explosion.

It is another object of the present invention to provide an evaporation apparatus for solvent fuel, which is a non-poisonous, non-pollution, environmentally conscious, effective, safe, and inexpensive energy, and which does not impose an immediate danger to human body when leakage occurs.

To achieve this object, the air (necessary for its oxygen content) is introduced into the solvent which is the production of petroleum or wax distilled at the temperature 60° C˜150° C. Furthermore, a small amount of highly volatile acetone, or other organic compound, such as industrial alcohol may be added to improve the evaporation efficiency.

It is one more object of the present invention to provide an evaporation apparatus for solvent fuel capable of versatilely supplying the fuel to any types of burner.

To achieve this object, a suitable type or capacity of blower can be incorporated with this apparatus.

For fuller understanding of the nature and objects of the invention, reference should be made to the following detailed description taken in conjunction with the accompanying drawings.

### BRIEF DESCRIPTION OF THE DRAWINGS

FIG. 1 is a three-dimensional view of the present invention;

FIG. 2 is the longitudinal cross-sectional view of the present invention;

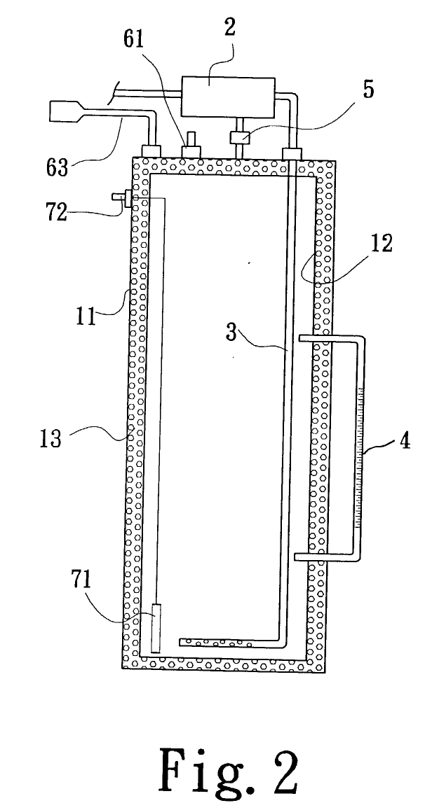

FIG. 3 is a schematic view illustrating the operation of the present invention.

### DETAILED DESCRIPTION OF THE PREFERRED EMBODIMENT

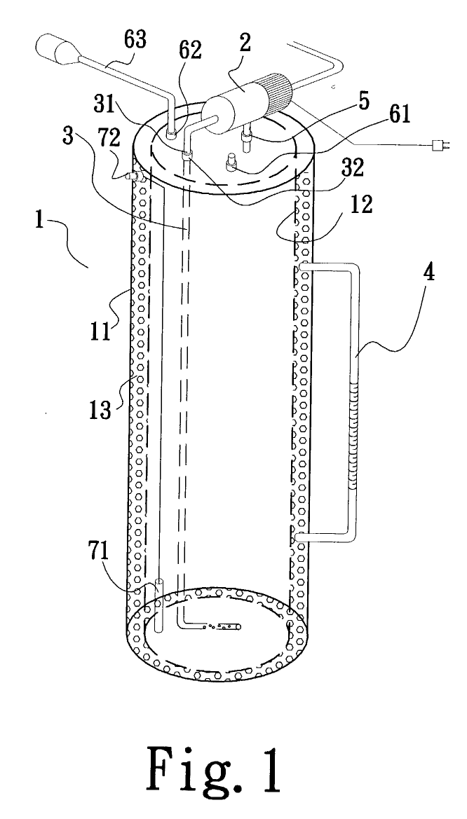

Referring to FIG. 1, this is the three-dimensional view of the evaporation apparatus for solvent fuel of the present invention. As shown in FIG. 1, the evaporation tank (container) 1, a blower (motor) 2, an air inlet pipe 3, and a scale graduation tube 4. The evaporation tank 1 consists of an outer tank 11, an inner tank 12, the outer tank 11, preferably made of a non-heat conductive material, serves as a protective wall, while the inner tank 12 is made of anti-corrosion stainless steel or the likes. A heat insulation barrier 13 is intercalated there between such that the solvent fuel, which is stored in the inner tank 12, is not influenced by the outside thermal condition.

The blower 2 installed on the top of the evaporation tank 1, is connecting its one end to the air inlet pipe 3, the air inlet pipe 3 is provided with a blower switch 31 associated with a check valve 32 at a suitable position so as to determine the blowing time, and check back flow of the air and solvent fuel. The air inlet pipe 3 is deeply extended to the bottom of the inner tank 12 along the longitudinal direction thereof so as to facilitate the air to mix with the solvent fuel and evaporate the solvent fuel. The other end of the blower 2 is connected to a pressure switch 5 for controlling operation of the blower 2 by detecting the inner pressure of the tank 1. The scale graduation tube 4 attached to the outer surface of the evaporation tank 1 is used to measure the quantity of the solvent in the tank 1.

A solvent fuel inlet switch 61 and a gas fuel outlet switch 62 are both provided on the top of the evaporation tank 1. The latter (62) is connected to a gas fuel outlet pipe 63, which is extended to a burner 7 (said a gas burner or an automobile engine). A constant temperature rod 71 provided nearby the bottom of the inner tank 12 with its one end connected to a temperature control switch 72 can maintain the inner tank 12 at a constant temperature by actuation of the switch 72.

The solvent fuel used in the present invention is a general solvent by the name Multipurpose Mineral Spirit which is a refined petroleum or wax distilled at 60° C. (initiation boiling point)˜150° C. (final boiling point). A predetermined amount of alcoholic substance such as acetone or other highly volatile solvent like N-Hexane so as to fully solute the adulterants such as oil, water, and others in the solvent fuel thereby improving the fuel evaporation effect. Besides, the oil, water, and other adulterants mixed in the air introduced into the tank 1 may also be soluted by the aforementioned additives so that the apparatus of the present invention can be durably operated with a high efficiency.

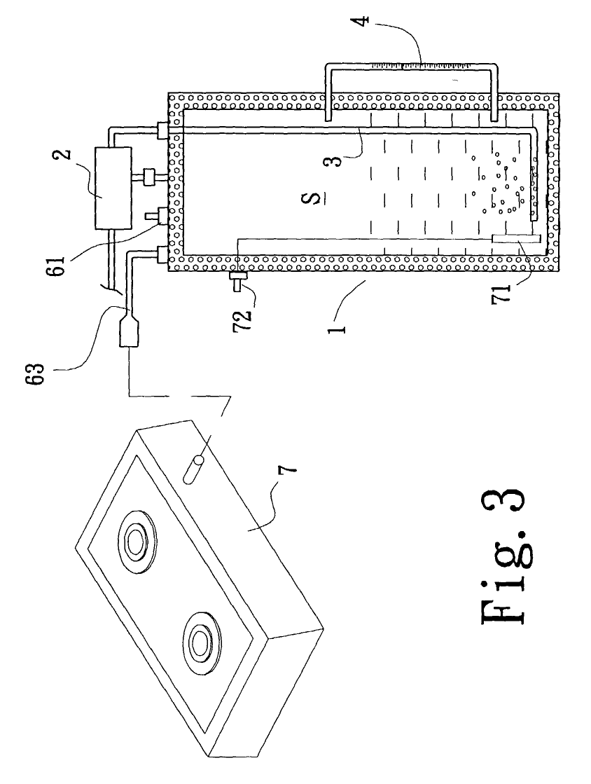

Referring to FIG. 3, this drawing shows a schematic view illustrating the operation of the evaporation apparatus for solvent fuel of the present invention. As shown in FIG. 3, the quantity of solvent fuel in the tank 1 can be directly observed by naked eyes from the scale graduation pipe 4. The above-described solvent fuel is filled into the tank 1 by opening the fuel inlet switch 61. Thereafter, the pressure in the tank 1 is detected by the pressure switch 5. If the condition shows that some gaseous fuel is demanded, the pressure switch 5 actuates the blower 2 to start thereby introducing extraneous air into the tank 1 via the air inlet pipe 3. Then, the solvent fuel is evaporated and supplied to the burner 7 via the gaseous fuel, outlet pipe 63. As mentioned above, the type of blower 2 may be varied to match the type of burner 7 no matter it belongs to a domestic gas oven or an industrial boiler.

In the present invention, the solvent fuel stored in the tank is output to the burner in the gaseous state by mixing air supplied from the blower so that there is almost no pressure inside the tank when the blower is operating. However, a prescribed pressure is maintained in the tank by the pressure switch that stops the blower operation.

In the present invention, it is unnecessary to use the constant temperature rod 71 when the apparatus is to be operated at the normal ambient temperature. However, the above-said constant temperature rod 71 is actuated by the switch 72 to maintain a constant temperature of 30˜35° C. in the tank 1 in the cold environment so as to prevent degradation of fuel evaporation efficiency.

From the above description, the evaporation apparatus for solvent fuel of the present invention has several noteworthy merits i.e.

1. The apparatus can be securely operated because the fuel tank does not have to withstand a high pressure.

2. Either DC or AC can be used to operate the apparatus.

3. A high burning temperature of 1000° C. can be attained (compares to 700° C. for domestic LPG) owing to the fact that the sufficient oxygen is forced into the tank by the blower via air inlet pipe so that the burning efficiency can be kept at better condition than any conventional liquid fuel whose burning efficiency goes down as the amount of supplied extraneous air decreased when the amount of liquid fuel (and the accompanied pressure) remained in the fuel tank decreases. This principle can be illustrated by an example of cutting steel plate at 2000° C. high temperature where an oxygen tank is accompanied with a liquid fuel tank for supplying necessary amount of oxygen so as to carry out the cutting work.

4. No fear of leakage of poisonous substance from the apparatus of the present invention because there is no pressure held in the fuel tank. On the contrary, the conventional high pressure propane fuel bomb is always under the fear of leaking large amount of poisonous gas due to inadvertent handling and maintenance, which imposes an immediate danger to human body.

5. No fear of explosion because there is no pressure held in the fuel tank, and the heavy and larger solvent fuel molecule is hard to incur explosion even though there was a small amount of leakage. On the contrary, a conventional propane fuel bomb is always in the danger of explosion due to high pressure and small, light weighted molecules of propane contained in the fuel tank, and when certain amount is gathered, an area of explosion points is easily formed.

6. The amount of fuel in the tank can be observed with naked eyes from the scale graduation pipe at any time.

Those who are skilled in the art will readily perceive how to modify the invention. Therefore the appended claims are to be construed to cover all equivalent structures, which fall within the true scope and spirit of the invention.

What is claimed is:

1. Evaporation apparatus for solvent fuel comprising:
1. An evaporation tank, a blower, an air inlet pipe, and a scale graduation tube; wherein a solvent fuel is contained in said evaporation tank, said blower is installed on the top of said evaporated tank and is connecting its one end to said air inlet pipe, while its other end is connected to a pressure switch for controlling operation of said blower by detecting inner pressure of said evaporation tank, said air inlet pipe is provided with a blower switch associated with a check value at a relevant position, said air inlet pipe is deeply extended to the bottom of said evaporation tank along the longitudinal direction thereof so as to facilitate the air to mix with the solvent fuel and evaporate it, said scale graduation tube is attached to the outer side surface of said evaporation tank to measure the solvent fuel quantity in said evaporation tank, said evaporation apparatus is non-compressed, and the user is able to add the solvent fuel through a refill hole (solvent fuel inlet) without the danger of an explosion or leakage of poisonous substance.
2. The evaporation apparatus of claim 1, wherein said evaporation tank is composed of an outer tank and an inner tank, said outer tank, made of a non-heat conductive material, serves as a protective wall, while said inner tank containing the solvent fuel, is made of anti-corrosive stainless steel, wherein a heat insulation barrier is intercalated there between such that said inner tank which is storing the solvent fuel is not influenced by the outside thermal condition.
3. The evaporation apparatus of claim 2, wherein a constant temperature rod is provided nearby the bottom of said inner tank with its one end in connection with a temperature control switch to maintain said inner tank at a constant temperature.
